(19) United States
(12) Patent Application Publication
(10) Pub. No.: US 2008/0196178 A1
(43) Pub. Date: Aug. 21, 2008

(54) Mixture of Water-Soluble Fibre-Reactive Dyes, Method for the Production Thereof, and Use of the Same

(75) Inventors: Jorg Diekmann, Bad Camberg (DE); Birgit Eden, Idstein (DE); Stefan Meier, Frankfurt (DE); Ludger Wilbers, Niedernhausen (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG I, Frankfurt am Main (DE)

(21) Appl. No.: 11/915,075

(22) PCT Filed: Jun. 20, 2006
(86) PCT No.: PCT/EP2006/063338

§ 371 Date: Nov. 20, 2007

(30) Foreign Application Priority Data
Jun. 24, 2005 (DE) 10 2005 029 383.2

(51) Int. Cl. C09B 67/22; C09D 11/00

(52) U.S. Cl. 8/549; 8/543; 106/31.47; 106/31.43

(57) ABSTRACT

Dye mixtures including the dyes of the general formula (I) and dyes of the general formula (II)

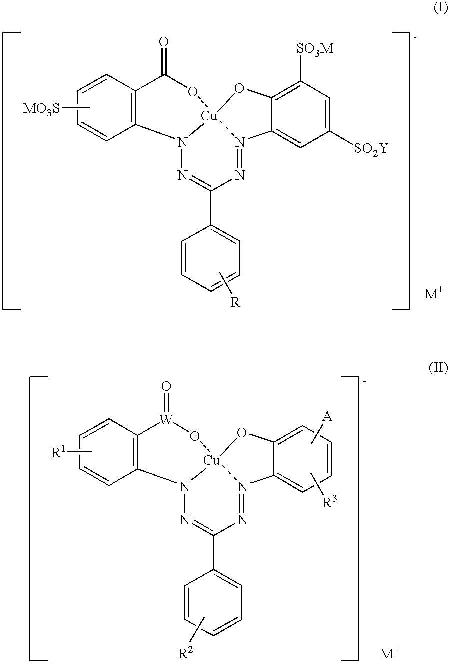

where R¹ to R³, A, W and M are each as defined in claim 1, their preparation and their use for dyeing or printing hydroxyl- and/or carboxamido-containing material, preferably fiber material.

This invention relates to the technical field of fiber-reactive dyes.

Numerous fiber-reactive dye mixtures are known, for example from the documents U.S. Pat. No. 6,143,039, EP 0 735 111 and EP 0 832 939 and also the Japanese references JP5-70707 and JP2-99564, for producing blue dyeings on hydroxyl- and/or carboxamido-containing fibers, such as cellulosic fibers in particular In addition, EP-A 668 328 describes numerous mixtures of fiber-reactive dyes, in each of which one dye component is employed as a shading component.

However, these dye mixtures have certain application defects, for example an excessive dependence of the color yield on changing dyeing parameters in the dyeing operation, or an inadequate or unlevel build-up on cotton, good build-up resulting from the ability of a dye to provide a stronger dyeing when used in a higher dye concentration in the dyebath. One consequence of these defects can be poor reproducibilities for the dyeings which are obtainable.

However, it is especially important to obtain dyeings having a good color yield, i.e. dyeings whose depth of shade is very high in relation to the amount of dye used, for example owing to a high absorbance and owing to good dyeing characteristics of this dye, for example a high affinity and a high fixation yield. When mixtures of dyes having a certain color yield are used, it is the rule that the color yield of these mixtures of dyes is the sum total of the color yields of the individual dyes, which is why the color yield of a mixture of, for example, two dyes will be lower than the color yield obtained when the dye having the larger color yield property is used as the only dye but in the total amount of the two individual dyes. This also applies to the service fastnesses such as the light, wash, hotpress and chlorine fastnesses for example. With these fastnesses, moreover, there is often a negative synergy effect known as catalytic fading, so that fastnesses of mixtures can be less than those of the individual dyes.

The present inventors have now found that, surprisingly, the color strength of the hereinbelow described dye mixtures according to the present invention is surprisingly higher than the sum total of the color strengths afforded by the individual dyes in the dye mixture. This positive synergistic effect also shows itself in improved build-up for the mixture according to the present invention compared with that of the individual dyes in the mixture and also in fastnesses which in some instances are superior to the average of the individual fastnesses.

The present invention accordingly provides dye mixtures including at least one dye of the general formula (I) and at least one dye of the general formula (II)

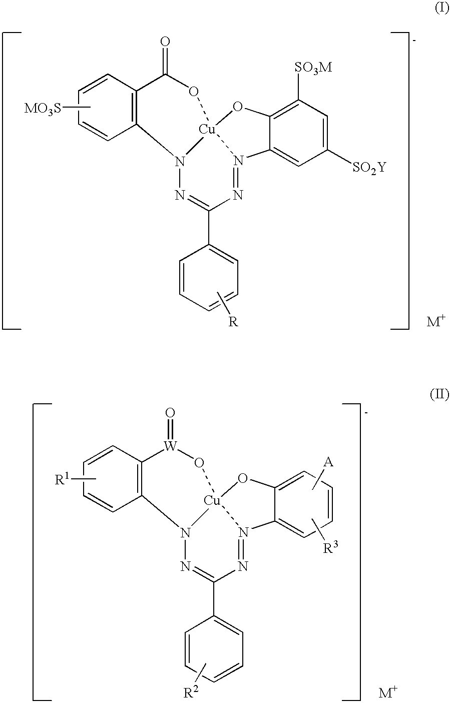

where
M is hydrogen or an alkali metal, an ammonium or the equivalent of an alkaline earth metal ion;
Y is vinyl or a grouping of the formula CH₂CH₂Z, where Z is an alkali-eliminable grouping such as for example chloro, acetyl, phosphato, thiosulfato and is more preferably sulfato;
R¹ is hydrogen or sulfo;
R² has one meaning of R¹ or is methyl, methoxy, carboxyl or SO₂Y², where Y² has one meaning of Y and preferably is CH₂CH₂Cl or vinyl;
R³ has one meaning of R¹;
R has one meaning of R²;
W is carbon or —SO—;
A is a grouping of the general formula (3)

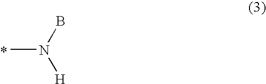

where
* denotes the bond to the formazan and
B is a grouping of the general formulae (4), (5), (6) or (7)

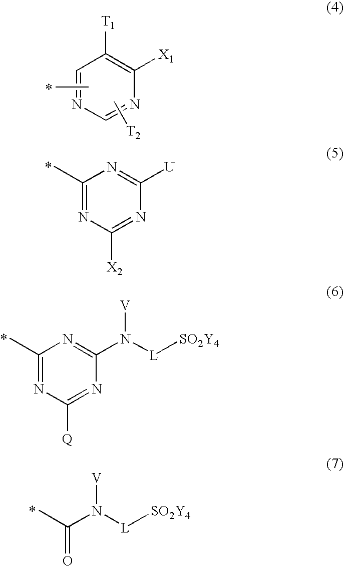

where
* is the bond to N in the formula (3)
U is a 5- or 6-membered N-attached heterocyclic ring which may be substituted with a thio or oxo group;

preferably U is morpholine, or else a group of the general formula (8)

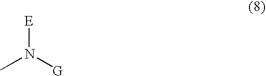

where
E is hydrogen, unsubstituted or methoxy-, hydroxyl-, sulfato-, sulfo- or chloro-substituted C₁-C₄-alkyl or is phenyl which may be substituted by one or 2 substituents selected from the group consisting of chlorine, nitro, acetylamino, sulfo, hydroxyl, carboxyl, C₁-C₄-alkanoyl, C₁-C₄-alkoxy and C₁-C₄-alkyl, E is preferably hydrogen, phenyl, 4-chlorophenyl, 3-sulfophenyl, methyl, 2-hydroxyethyl, 2-sulfoethyl, 2-sulfatoethyl;
G has one of the meanings of E or is cyano and preferably hydrogen;
L is phenylene or naphthylene which may each be substituted by up to two substituents selected from the group consisting of chloro, bromo, hydroxyl, C₁-C₄-alkoxy, especially methoxy, C₁-C₄-alkyl especially methyl, ethyl, sulfo, cyano; or L is C₂-C₆-alkylene, which may be interrupted by 1 to 2 hetero groups, such as for example oxo, thio, amino, C₁-C₄-alkylamino; L is preferably phenylene, ethylene, propylene, 3-oxopentylene;
Q is fluorine, chlorine, C₁-C₄ alkoxy, cyanamido, amino, C₁-C₄-alkylamino, dialkylamino, piperazine, morpholine or a group of the formula (9a) or (9b)

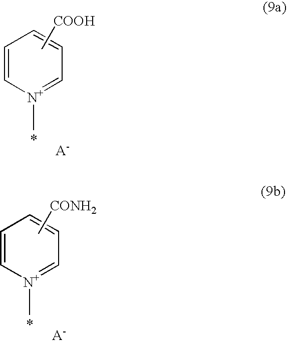

where A⁻ is fluoride, chloride or the equivalent of a sulfate ion;
V has one of the meanings of E and preferably is hydrogen, methyl, phenyl or sulfophenyl;
T¹ is hydrogen, fluorine or chlorine;
T² is hydrogen, fluorine or chlorine, subject to the proviso that T¹ and T² are not both hydrogen;
X¹ is fluorine or chlorine; and
X² has one meaning of X¹.

In general, the dye of the general formula (I) and the dye of the general formula (II) are present in the mixture in a mixing ratio of 90:10% by weight to 10:90% by weight and preferably in a ratio of 80:20% by weight to 20:80% by weight. More preferably, the two dyes are present in the dye mixture according to the present invention in a ratio of 65:35 to 35:65% by weight.

The dye mixtures of the present invention can be present as a preparation in solid or in liquid (dissolved) form. In solid form, they generally include the electrolyte salts customary for water-soluble and especially for fiber-reactive dyes, such as sodium chloride, potassium chloride and sodium sulfate, and may further include the auxiliaries customary in commercial dyes, such as buffer substances capable of setting a pH in aqueous solution between 3 and 7, such as sodium acetate, sodium borate, sodium bicarbonate, sodium dihydrogenphosphate, sodium citrate and disodium hydrogenphosphate, or small amounts of siccatives or, when they are present in a liquid, aqueous solution (including the presence of thickeners of the type customary in print pastes) they may also include substances which ensure a long life for these preparations, for example mold preventatives.

In general, the dye mixtures of the present invention are present as dye powders containing 10% to 80% by weight, based on the dye powder or the preparation, of an electrolyte salt which is also known as a standardizing agent. These dye powders may additionally include the aforementioned buffer substances in a total amount of up to 10% by weight, based on the dye powder. When the dye mixtures of the present invention are present in aqueous solution, the total dye content of these aqueous solutions will be up to about 75% by weight, for example between 5 and 75% by weight, and the electrolyte salt content of these aqueous solutions will preferably be below 10% by weight, based on the aqueous solution; the aqueous solutions (liquid preparations) may include the aforementioned buffer substances in an amount which is generally up to 10% by weight and preferably up to 2% by weight.

Dyes of the general formula (I) are known and can be synthesized as described in U.S. Pat. No. 4,336,190 and U.S. Pat. No. 4,370,145, EP-A 0 028 788 and EP-A 0 028 787. For instance, common diazotization and coupling reaction can be used to construct the formazan compounds and, at the same time, the present invention's dyes of the formula (I) prepared in a manner familiar to one skilled in the art, by coppering.

Dyes of the general formula (II) are known for example from the patent documents EP 0 021 351, EP 0 099 721, EP-A 629 667, EP-A 625551, EP-A 626429, DE-A 4 320 632, WO 9418381 and EP-A 644 239.

The dye mixtures of the present invention are preparable in a conventional manner, for instance by mechanically mixing the individual dyes, which are present in solid or in liquid form, in the requisite proportions.

The dye mixtures of the present invention have useful application properties. They are used for dyeing or printing hydroxyl- and/or carboxamido-containing materials, for example in the form of sheetlike structures, such as paper and leather or of films, for example composed of polyamide, or in bulk, as for example of polyamide and polyurethane, but especially for dyeing or printing these materials in fiber form. Similarly, the solutions of the dye mixtures of the present invention that are obtained in the synthesis of the compounds, if appropriate after addition of a buffer substance and if appropriate after concentrating or diluting, can be used directly as liquid preparation for dyeing.

The present invention thus also relates to the use of the dye mixtures of the present invention for dyeing or printing these materials, or rather to processes for dyeing or printing these materials in a conventional manner, by using a dye mixture of the present invention as colorant. The materials are preferably employed in the form of fiber materials, especially in the form of textile fibers, such as woven fabrics or yarns, as in the form of hanks or wound packages.

Hydroxyl-containing materials are those of natural or synthetic origin, for example cellulose fiber materials or their regenerated products and polyvinyl alcohols. Cellulose fiber materials are preferably cotton, but also other vegetable fibers, such as linen, hemp, jute and ramie fibers; regenerated cellulose fibers are for example staple viscose and filament viscose.

Carboxamido-containing materials are for example synthetic and natural polyamides and polyurethanes, especially in the form of fibers, for example wool and other animal hairs, silk, leather, nylon-6,6, nylon-6, nylon-11 and nylon-4.

The dye mixtures of the present invention can be applied to and fixed on the substrates mentioned, especially the fiber materials mentioned, by the application techniques known for water-soluble dyes, especially fiber-reactive dyes.

For instance, on cellulose fibers they produce by the exhaust method from a long liquor using various acid-binding agents and optionally neutral salts, such as sodium chloride or sodium sulfate, dyeings having very good color yields which are improved compared with the individual dyes. Application is preferably from an aqueous bath at temperatures between 40 and 105° C., optionally at a temperature of up to 130° C. under superatmospheric pressure, and optionally in the presence of customary dyeing auxiliaries. One possible procedure is to introduce the material into the warm bath and to gradually heat the bath to the desired dyeing temperature and to complete the dyeing process at that temperature. The neutral salts which accelerate the exhaustion of the dyes may also, if desired, only be added to the bath after the

actual dyeing temperature has been reached.

The padding process likewise provides excellent color yields and very good color build-up on cellulose fibers, the dyes being allowed to become fixed on the material by batching at room temperature or at elevated temperature, for example at up to 60° C., by steaming or using dry heat in a conventional manner.

Similarly, the customary printing processes for cellulose fibers, which can be carried out either single-phase, for example by printing with a print paste comprising sodium bicarbonate or some other acid-binding agent and by subsequent steaming at 100 to 103° C., or two-phase, for example by printing with a neutral or weakly acidic print color and subsequent fixation either by passing the printed material through a hot electrolyte-comprising alkaline bath or by overpadding with an alkaline electrolyte-comprising padding liquor with subsequent batching of the alkali-overpadded material or subsequent steaming or subsequent treatment with dry heat, produce strong prints with well-defined contours and a clear white ground. The appearance of the prints is not greatly affected by variations in the fixing conditions.

When fixing by means of dry heat in accordance with the customary thermofix processes, hot air from 120 to 200° C. is used. In addition to the customary steam at 101 to 103° C. it is also possible to use superheated steam and high-pressure steam at temperatures of up to 160° C.

The acid-binding agents which effect the fixation of the dyes of the dye mixtures of the present invention on the cellulose fibers include for example water-soluble basic salts of the alkali metals and likewise alkaline earth metals of inorganic or organic acids or compounds which liberate alkali in the heat. Especially suitable are the alkali metal hydroxides and alkali metal salts of weak to medium inorganic or organic acids, the preferred alkali metal compounds being the sodium and potassium compounds. Such acid-binding agents include for example sodium hydroxide, potassium hydroxide, sodium carbonate, sodium bicarbonate, potassium carbonate, sodium formate, sodium dihydrogenphosphate, disodium hydrogenphosphate, sodium trichloroacetate, waterglass or trisodium phosphate.

The dye mixtures of the present invention are notable for a high yield of fixation when applied to the cellulose fiber materials by dyeing or printing. The cellulose dyeings obtained following the customary aftertreatment by rinsing to remove unfixed dye portions exhibit excellent wetfastnesses, in particular since such unfixed dye portions are easily washed off on account of their good solubility in cold water.

The present invention further provides for the use of the present invention's dye mixtures in printing inks for digital textile printing by the ink jet process.

The printing inks of the invention include one or more of the stated reactive dyes, in amounts for example of 0.1% to 50% by weight, preferably in amounts of 1% to 30% by weight, and more preferably in amounts of 1% to 15% by weight, based on the total ink weight. Likewise included may be combinations of the stated reactive dyes with other reactive dyes used in textile printing. For the inks to be used in a continuous flow process, a conductivity of 0.5 to 25 mS/m can be set by adding electrolyte.

Examples of suitable electrolyte include the following: lithium nitrate, potassium nitrate.

The dye inks of the invention may contain organic solvents in a total amount of 1-50%, preferably of 5-30% by weight.

Examples of suitable organic solvents are

alcohols, for example, methanol, ethanol, 1-propanol, isopropanol, 1-butanol, tert-butanol, pentyl alcohol, polyhydric alcohols, for example, 1,2-ethanediol, 1,2,3-propanetriol, butanediol, 1,3-butanediol, 1,4-butanediol, 1,2-propanediol, 1,3-propanediol, pentanediol, 1,4-pentanediol, 1,5-pentanediol, hexanediol, D,L-1,2-hexanediol, 1,6-hexanediol, 1,2,6-hexanetriol, 1,2-octanediol, polyalkylene glycols, for example, polyethylene glycol, polypropylene glycol, alkylene glycols having 2 to 8 alkylene groups, for example, monoethylene glycol, diethylene glycol, triethylene glycol, tetraethylene glycol, thioglycol, thiodiglycol, butyl triglycol, hexylene glycol, propylene glycol, dipropylene glycol, tripropylene glycol, lower alkyl ethers of polyhydric alcohols, for example, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol monohexyl ether, triethylene glycol monomethyl ether, triethylene glycol monobutyl ether, tripropylene glycol monomethyl ether, tetraethylene glycol monomethyl ether, tetraethylene glycol monobutyl ether, tetraethylene glycol dimethyl ether, propylene glycol monomethyl ether, propylene glycol monoethyl ether, propylene glycol monobutyl ether, tripropylene glycol isopropyl ether, polyalkylene glycol ethers, for example, polyethylene glycol monomethyl ether, polypropylene glycol glycerol ether, polyethylene glycol tridecyl ether, polyethylene glycol nonylphenyl ether, amines, for example, methylamine, ethylamine, triethylamine, diethylamine, dimethylamine, trimethylamine, dibutylamine, diethanolamine, triethanolamine, N-acetylethanolamine, N-formylethanolamine, ethylenediamine, urea derivatives, for example, urea, thiourea, N-methylurea, N,N′-dimethylurea, ethyleneurea, 1,1,3,3-tetramethylurea, amides, for example, dimethylformamide, dimethylacetamide, acetamide, ketones or keto alcohols, for example, acetone, diacetone alcohol, cyclic ethers, for example, tetrahydrofuran, dioxane, trimethylolethane, trimethylolpropane, 2-butoxyethanol, benzyl alcohol, gamma-butyrolactone, epsilon-caprolactam, additionally sulfolane, dimethylsulfolane, methylsulfolane, dimethyl sulfone, butadiene sulfone, dimethyl sulfoxide, dibutyl sulfoxide, N-cyclohexylpyrrolidone, N-methyl-2-pyrrolidone, N-ethylpyrrolidone, 2-pyrrolidone, 1-(2-hydroxyethyl)-2-pyrrolidone, 1-(3-hydroxypropyl)-2-pyrrolidone, 1,3-dimethyl-2-imidizolidinone, 1,3-dimethyl-2-imidazolinone, 1,3-bismethoxymethylimidazolidine, 2-(2-methoxyethoxy}ethanol, 2-(2-ethoxyethoxy)ethanol, 2-(2-butoxyethoxy)ethanol, 2-(2-propoxyethoxy)ethanol, pyridine, piperidine, trimethylolpropane, 1,2-dimethoxypropane, ethyl acetate, ethylenediaminetetraacetate, ethyl pentyl ether.

The printing inks of the invention may further comprise the customary additives, such as viscosity moderators to set viscosities in the range from 1.5 to 40.0 mPas in a temperature range from 20 to 50° C. Preferred inks have a viscosity of 1.5 to 20 mPas, particularly preferred inks a viscosity of 1.5 to 15 mPas.

Suitable viscosity moderators include rheological additives, examples of which include the following:

polyvinylcaprolactam, polyvinylpyrrolidoner and their copolymers, polyetherpolyol, associative thickeners, polyurea, polyurethane, sodium alginates, modified galactomannans, polyetherurea, polyurethane, nonionic cellulose ethers.

As further additives the inks of the invention may include surface-active substances for setting surface tensions of 20 to 65 mN/m, which where appropriate are adapted to the technique used (thermo or piezo technology). Examples of suitable surface-active substances include the following: surfactants of all kinds, preferably nonionic surfactants, butyidiglycol, 1,2-hexanediol.

The inks may further comprise customary additives, such as fungal and bacterial growth inhibitors in amounts of 0.01% to 1% by weight, based on the total ink weight.

The inks may be prepared in conventional manner by mixing of the components in water.

The dye inks of the invention are suitable for use in ink jet printing processes for printing any of a very wide variety of pretreated materials, such as silk, leather, wool, polyamide fibers and polyurethanes, and especially cellulosic fiber materials of any kind. Examples of such fiber materials are the natural cellulosic fibers, such as cotton, linen and hemp, and also chemical pulp and regenerated cellulose. The printing inks of the invention are also suitable for printing pretreated hydroxyl-containing and/or amino-containing fibers present in blends, examples being blends of cotton, silk, wool with polyester fibers or polyamide fibers.

In contrast to conventional textile printing, where the printing ink already includes all of the fixing chemicals and thickeners for a reactive dye, in the case of ink jet printing the auxiliaries must be applied to the textile substrate in a separate pretreatment step.

Pretreatment of the textile substrate, such as cellulose and regenerated cellulose fibers and also silk and wool, is carried out with an aqueous alkaline liquor prior to printing. To fix reactive dyes alkali is needed, examples being sodium carbonate, sodium bicarbonate, sodium acetate, trisodium phosphate, sodium silicate, sodium hydroxide, alkali donors such as, for example, sodium chloroacetate, sodium formate, hydrotropic substances such as, for example, urea, reduction inhibitors, such as, for example, sodium nitrobenzenesulfonates, and also thickeners to prevent flowing of the motifs when the printing ink is applied—examples of these are sodium alginates, modified polyacrylates and highly etherified galactomannans.

These pretreatment reagents are applied uniformly to the textile substrate in a defined amount using suitable applicators, such as with a 2- or 3-roll pad, with contactless spraying technologies, by means of foam application, or using appropriately adapted ink jet technologies, and the treated substrate is subsequently dried.

After printing, the textile fiber material is dried at 120 to 150° C. and then fixed. The ink jet prints produced with reactive dyes can be fixed at room temperature or with saturated steam, with superheated steam, with hot air, with microwaves, with infrared radiation, with laser or electron beams or with other suitable energy transfer methods.

A distinction is made between one- and two-phase fixing operations:

In one-phase fixing, the chemicals needed for fixing are already on the textile substrate.

In two-phase fixing this pretreatment is unnecessary. Fixing requires only alkali, which, following ink jet printing and prior to the fixing operation, is applied without intermediate drying. There is no need for further additives such as urea or thickener.

Fixing is followed by print aftertreatment, which is the prerequisite for good fastnesses, high brilliance and an impeccable white ground.

The dyeings and prints produced with the dye mixtures of the invention, possess bright shades; in particular on cellulose fiber materials they possess good lightfastness and very good wetfastness properties, such as wash, milling water, seawater, cross-dyeing and acidic and alkaline perspiration fastnesses, and also good fastness to dry heat setting and pleating and to crocking.

Furthermore, the dye mixtures of the present invention can also be used for the fiber-reactive dyeing of wool. Moreover, wool which has been given a nonfelting or low-felting finish (cf. for example H. Rath, Lehrbuch der Textilchemie, Springer-Verlag, 3rd Edition (1972), p. 295-299, especially the finish by the Hercosett process (p. 298); J. Soc. Dyers and Colourists 1972, 93-99, and 1975, 33-44) can be dyed with very good fastness properties.

The process of dyeing on wool is here carried out in a conventional manner from an acidic medium. For instance, acetic acid and/or ammonium sulfate or acetic acid and ammonium acetate or sodium acetate may be added to the dyebath to obtain the desired pH. To obtain a dyeing of acceptable levelness it is advisable to add a customary leveling agent, for example on the basis of a reaction product of cyanuric chloride with 3 times the molar amount of an aminobenzenesulfonic acid and/or of an aminonaphthalenesulfonic acid or on the basis of a reaction product of for example stearylamine with ethylene oxide. For instance, the dye mixture of the present invention is preferably subjected to the exhaust process initially from an acidic dyebath having a pH of about 3.5 to 5.5 under pH control and the pH is then, toward the end of the dyeing time, shifted into the neutral and optionally weakly alkaline range up to a pH of 8.5 to bring about, especially for very deep dyeings, the full reactive bond between the dyes of the dye mixtures of the present invention and the fiber. At the same time, the dye portion not reactively bound is removed.

The procedure described herein also applies to the production of dyeings on fiber materials composed of other natural polyamides or of synthetic polyamides and polyurethanes. In general, the material to be dyed is introduced into the bath at a temperature of about 40° C., agitated therein for some time, the dyebath is then adjusted to the desired weakly acidic, preferably weakly acetic acid, pH and the actual dyeing is carried out at a temperature between 60 and 98° C. However, the dyeings can also be carried out at the boil or in sealed dyeing apparatus at temperatures of up to 106° C. Since the water solubility of the dye mixtures of the present invention is very good, they can also be used with advantage in customary continuous dyeing processes. The color strength of the dye mixtures of the present invention is very high.

The dye mixtures of the present invention provide reddish to greenish blue dyeings or ink jet prints on the materials mentioned, preferably fiber materials.

The examples hereinbelow serve to illustrate the present invention. They are preparable in an inventive manner by mechanically mixing the individual dyes in solid or liquid form. Parts and percentages are by weight, unless otherwise stated. The compounds described in the examples in terms of a formula are in some instances indicated in the form of the free acids; in general they are prepared and isolated in the form of their salts, preferably sodium or potassium salts, and used for dyeing in the form of their salts.

The dye mixtures of the present invention have very good application properties and provide on the materials mentioned in the description, in particular cellulosic fiber materials, by the application methods customary in the art for dyeing and printing, preferably by the application and fixing methods customary in the art for fiber-reactive dyes, strong dyeings and prints having good fastness properties and particularly good tainting performance especially with regard to polyester in continuous dyeing by the pad-steam process.

The following compounds are used as examples of dyes of the formula (I):

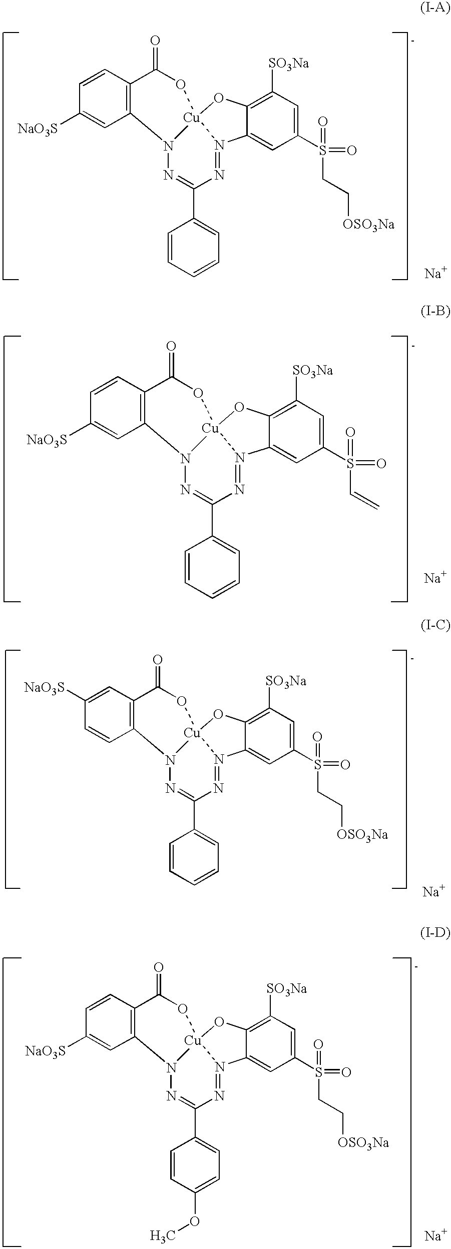

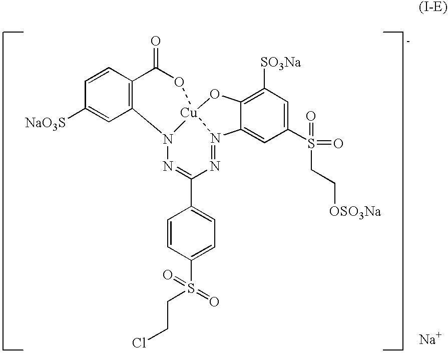

Examples of dyes of the formula (II) are obtained by reaction of the aminoformazan (2a-1) at 0-20° C. with trichlorotriazine and subsequent reaction of the dichlorotriazinyl compound (II-A) with N-ethyl-3-β-vinylsulfonylaniline at room temperature to form the present invention's dye (II-B).

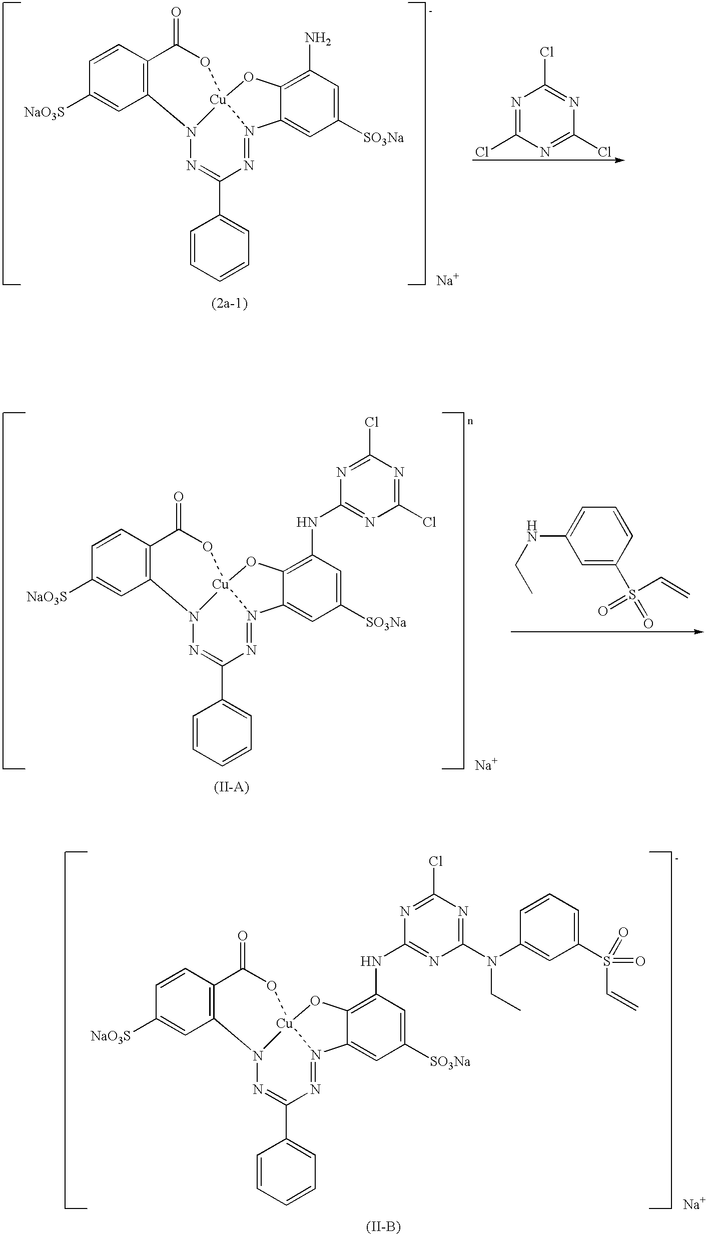

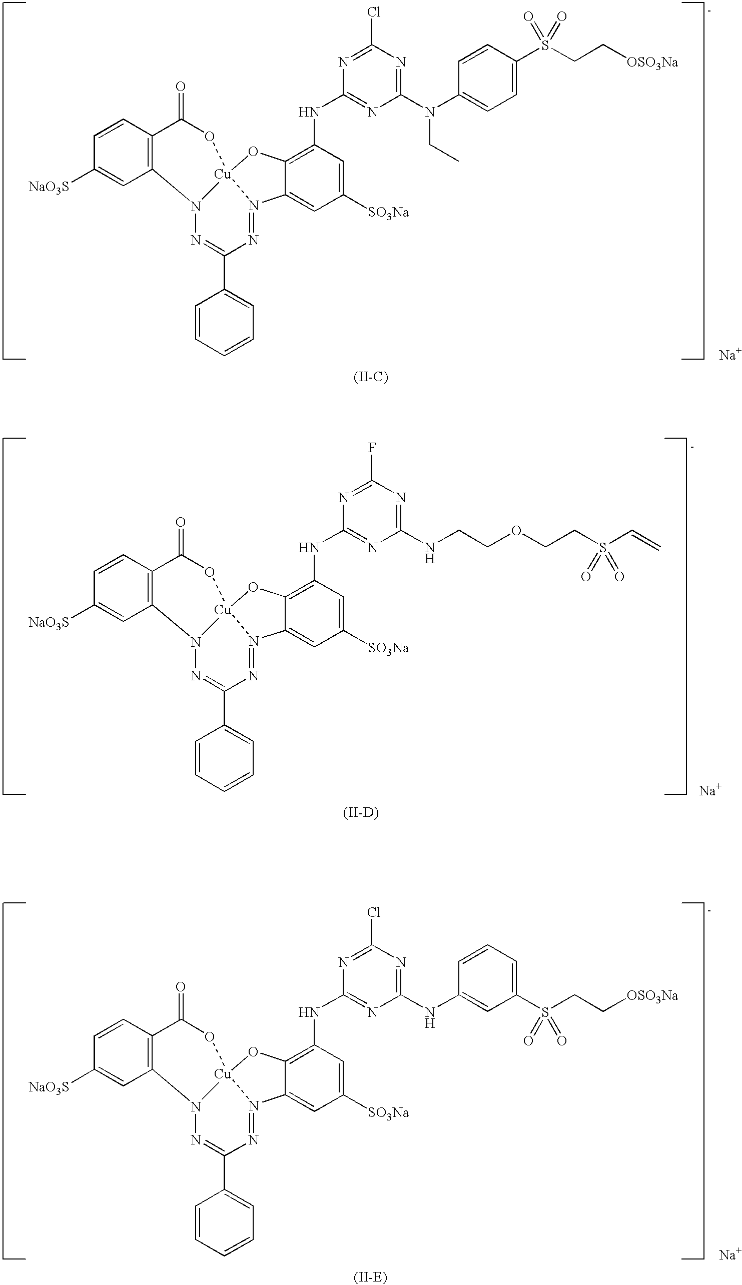

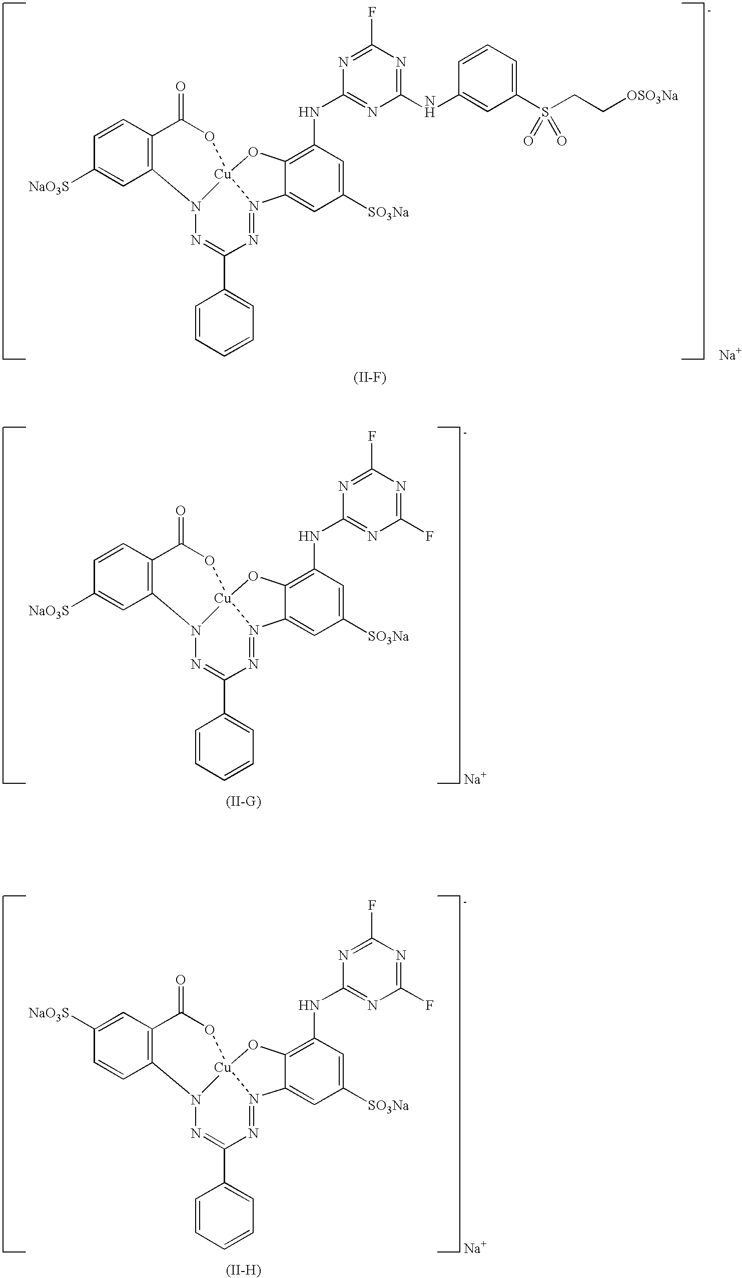

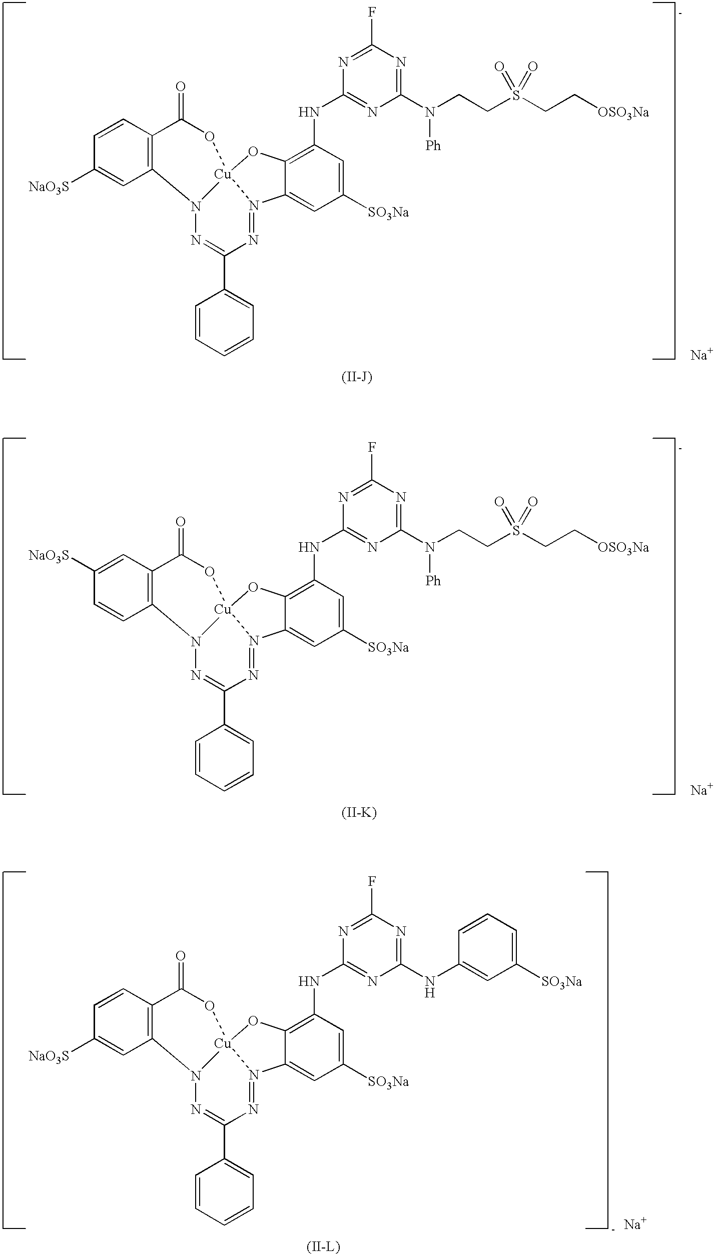

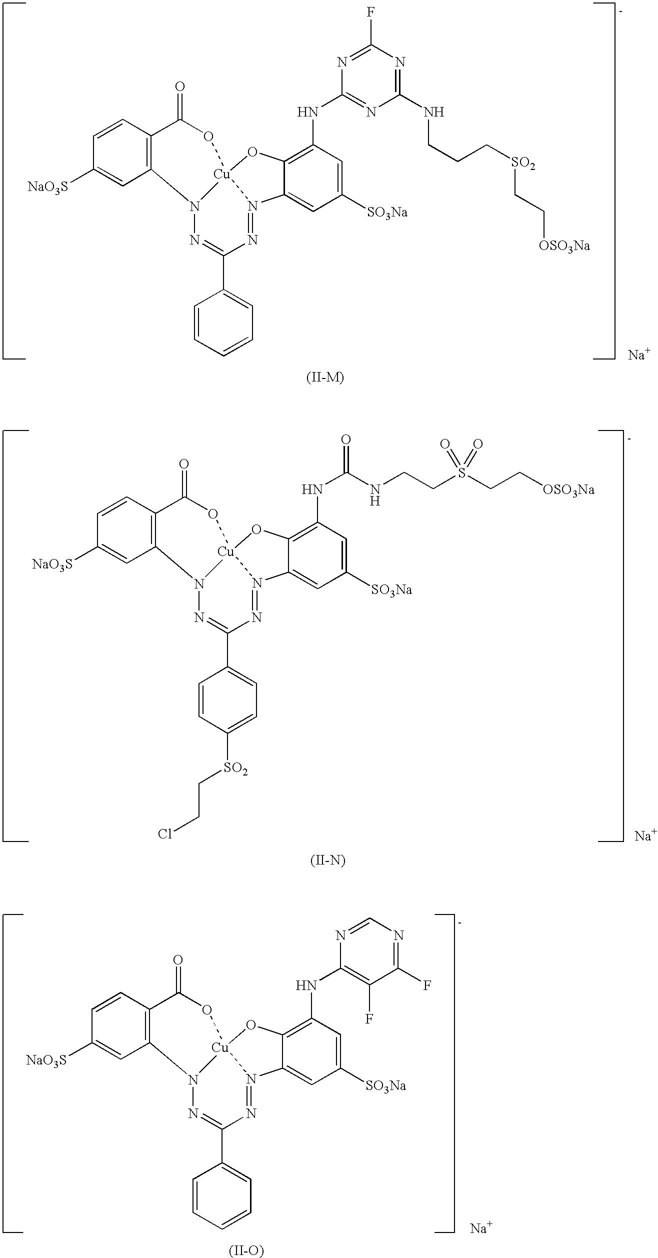

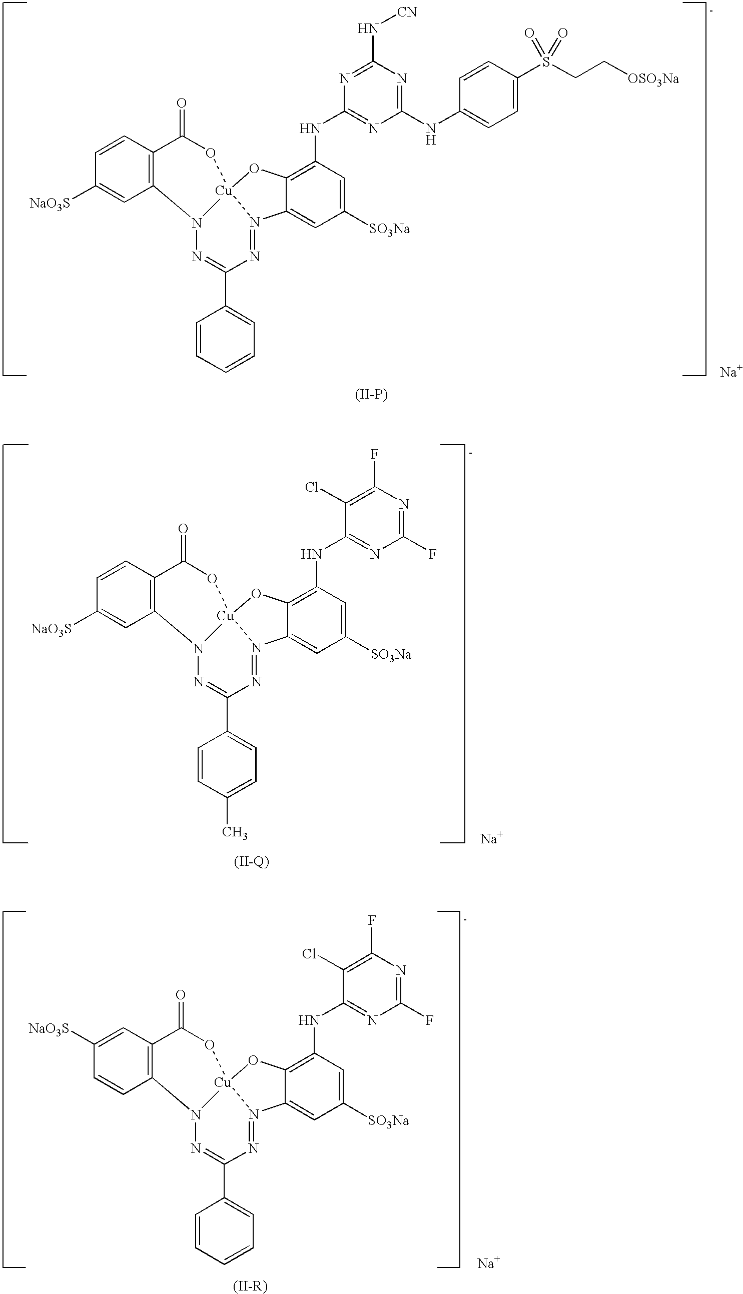

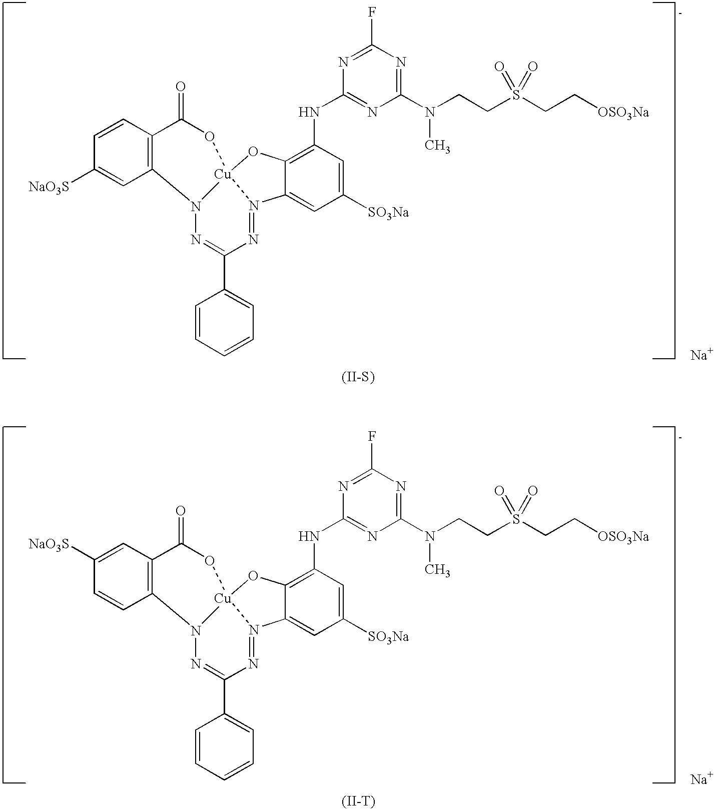

The following dyes conforming to the general formula (II) are prepared in a similar manner:

### EXAMPLES 1-162

The following mixtures according to the present invention are obtained by mixing aqueous solutions of formazan dyes of the formulae (I-A) to (I-E) with copper formazans of the formulae (II-B) to (II-T) in accordance with the quantitative fractions reported in the table and subsequent isolation by spray drying:

| Example | Dye (I) | Dye (II) | Ratio (I):(II) |
|---|---|---|---|
| 1 | (I-A) | (II-B) | 1:1 |
| 2 | (I-A) | (II-C) | 1:1 |
| 3 | (I-A) | (II-D) | 1:1 |
| 4 | (I-A) | (II-E) | 1:1 |
| 5 | (I-A) | (II-F) | 1:1 |
| 6 | (I-A) | (II-G) | 1:1 |
| 7 | (I-A) | (II-H) | 1:1 |
| 8 | (I-A) | (II-J) | 1:1 |
| 9 | (I-A) | (II-K) | 1:1 |
| 10 | (I-A) | (II-L) | 1:1 |
| 11 | (I-A) | (II-M) | 1:1 |
| 12 | (I-A) | (II-N) | 1:1 |
| 13 | (I-A) | (II-O) | 1:1 |
| 14 | (I-A) | (II-P) | 1:1 |
| 15 | (I-A) | (II-Q) | 1:1 |
| 16 | (I-A) | (II-R) | 1:1 |
| 17 | (I-A) | (II-S) | 1:1 |
| 18 | (I-A) | (II-T) | 1:1 |
| 19 | (I-A) | (II-B) | 2:1 |
| 20 | (I-A) | (II-C) | 2:1 |
| 21 | (I-A) | (II-D) | 2:1 |
| 22 | (I-A) | (II-E) | 2:1 |
| 23 | (I-A) | (II-F) | 2:1 |
| 24 | (I-A) | (II-G) | 2:1 |
| 25 | (I-A) | (II-H) | 2:1 |
| 26 | (I-A) | (II-J) | 2:1 |
| 27 | (I-A) | (II-K) | 2:1 |
| 28 | (I-A) | (II-L) | 2:1 |
| 29 | (I-A) | (II-M) | 2:1 |
| 30 | (I-A) | (II-N) | 2:1 |
| 31 | (I-A) | (II-O) | 2:1 |
| 32 | (I-A) | (II-P) | 2:1 |
| 33 | (I-A) | (II-Q) | 2:1 |
| 34 | (I-A) | (II-R) | 2:1 |
| 35 | (I-A) | (II-S) | 2:1 |
| 36 | (I-A) | (II-T) | 2:1 |
| 37 | (I-A) | (II-B) | 1:2 |
| 38 | (I-A) | (II-C) | 1:2 |
| 39 | (I-A) | (II-D) | 1:2 |
| 40 | (I-A) | (II-E) | 1:2 |
| 41 | (I-A) | (II-F) | 1:2 |
| 42 | (I-A) | (II-G) | 1:2 |
| 43 | (I-A) | (II-H) | 1:2 |
| 44 | (I-A) | (II-J) | 1:2 |
| 45 | (I-A) | (II-K) | 1:2 |
| 46 | (I-A) | (II-L) | 1:2 |
| 47 | (I-A) | (II-M) | 1:2 |
| 48 | (I-A) | (II-N) | 1:2 |
| 49 | (I-A) | (II-O) | 1:2 |
| 50 | (I-A) | (II-P) | 1:2 |
| 51 | (I-A) | (II-Q) | 1:2 |
| 52 | (I-A) | (II-R) | 1:2 |
| 53 | (I-A) | (II-S) | 1:2 |
| 54 | (I-A) | (II-T) | 1:2 |
| 55 | (I-B) | (II-B) | 1:1 |
| 56 | (I-B) | (II-C) | 1:2 |
| 57 | (I-B) | (II-D) | 1:1 |
| 58 | (I-B) | (II-E) | 1:2 |
| 59 | (I-B) | (II-F) | 1:1 |
| 60 | (I-B) | (II-G) | 2:1 |
| 61 | (I-B) | (II-H) | 1:2 |
| 62 | (I-B) | (II-J) | 2:1 |
| 63 | (I-B) | (II-K) | 1:1 |
| 64 | (I-B) | (II-L) | 2:1 |
| 65 | (I-B) | (II-M) | 1:2 |
| 66 | (I-B) | (II-N) | 1:1 |
| 67 | (I-B) | (II-O) | 2:1 |
| 68 | (I-B) | (II-P) | 1:1 |
| 69 | (I-B) | (II-Q) | 1:2 |
| 70 | (I-B) | (II-R) | 1:2 |
| 71 | (I-B) | (II-S) | 2:1 |
| 72 | (I-B) | (II-T) | 1:2 |
| 73 | (I-C) | (II-B) | 1:1 |
| 74 | (I-C) | (II-C) | 2:1 |
| 75 | (I-C) | (II-D) | 1:1 |
| 76 | (I-C) | (II-E) | 1:2 |
| 77 | (I-C) | (II-F) | 1:1 |
| 78 | (I-C) | (II-G) | 2:1 |
| 79 | (I-C) | (II-H) | 1:2 |
| 80 | (I-C) | (II-J) | 2:1 |
| 81 | (I-C) | (II-K) | 1:1 |
| 82 | (I-C) | (II-L) | 2:1 |
| 83 | (I-C) | (II-M) | 1:2 |
| 84 | (I-C) | (II-N) | 1:1 |
| 85 | (I-C) | (II-O) | 2:1 |
| 86 | (I-C) | (II-P) | 1:1 |
| 87 | (I-C) | (II-Q) | 1:2 |
| 88 | (I-C) | (II-R) | 1:2 |
| 89 | (I-C) | (II-S) | 2:1 |
| 90 | (I-C) | (II-T) | 1:2 |
| 91 | (I-D) | (II-B) | 1:1 |
| 92 | (I-D) | (II-C) | 1:2 |
| 93 | (I-D) | (II-D) | 1:1 |
| 94 | (I-D) | (II-E) | 1:2 |
| 95 | (I-D) | (II-F) | 1:1 |
| 96 | (I-D) | (II-G) | 2:1 |
| 97 | (I-D) | (II-H) | 1:2 |
| 98 | (I-D) | (II-J) | 2:1 |
| 99 | (I-D) | (II-K) | 1:1 |
| 100 | (I-D) | (II-L) | 2:1 |
| 101 | (I-D) | (II-M) | 1:2 |
| 102 | (I-D) | (II-N) | 1:1 |
| 103 | (I-D) | (II-O) | 2:1 |
| 104 | (I-D) | (II-P) | 1:1 |
| 105 | (I-D) | (II-Q) | 1:2 |
| 106 | (I-D) | (II-R) | 1:2 |
| 107 | (I-D) | (II-S) | 2:1 |
| 108 | (I-D) | (II-T) | 1:2 |
| 109 | (I-E) | (II-B) | 1:1 |
| 110 | (I-E) | (II-C) | 1:2 |
| 111 | (I-E) | (II-D) | 1:1 |
| 112 | (I-E) | (II-E) | 1:2 |
| 113 | (I-E) | (II-F) | 1:1 |
| 114 | (I-E) | (II-G) | 2:1 |
| 115 | (I-E) | (II-H) | 1:2 |
| 116 | (I-E) | (II-J) | 2:1 |
| 117 | (I-E) | (II-K) | 1:1 |
| 118 | (I-E) | (II-L) | 2:1 |
| 119 | (I-E) | (II-M) | 1:2 |
| 120 | (I-E) | (II-N) | 1:1 |
| 121 | (I-E) | (II-O) | 2:1 |
| 122 | (I-E) | (II-P) | 1:1 |
| 123 | (I-E) | (II-Q) | 1:2 |
| 124 | (I-E) | (II-R) | 1:2 |
| 125 | (I-E) | (II-S) | 2:1 |
| 126 | (I-E) | (II-T) | 1:2 |

Illustrative Dyeing 1:

To a solution of 3 parts of the dye mixture of Example (8) in 999 parts of water are added 5 parts of sodium chloride, 7 parts of sodium carbonate, 0.7 part of sodium hydroxide (in the form of an aqueous 32.5% solution) and 1 g of a customary wetting agent.

This dyeing liquor is entered with 100 g of bleached cotton tricot, maintained at 25° C. under constant mechanical agitation and subsequently heated to 60° C. at a rate of 1° C./min. The final temperature of the dyeing liquor is maintained for 60 to 90 minutes. Thereafter, the dyed material is removed and rinsed, initially for 5 minutes at the boil and then for 5 minutes at 60° C. The dyed fabric is then neutralized at 40° C. with 1000 parts of 0.05% acetic acid for 10 minutes, subsequently rinsed at 70° C. and thereafter soaped off at the boil with a laundry detergent for 15 minutes. After a further rinse the dyed material is dried to obtain a bright blue dyeing having good fastness properties.

Illustrative Dyeing 2

A textile fabric consisting of mercerized cotton is padded with a liquor including 35 g/l of anhydrous sodium carbonate, 100 g/l of urea and 150 g/l of a low viscosity sodium alginate solution (6%) and then dried. The wet pick-up is 70%. The textile thus pretreated is subsequently printed with an aqueous ink including

2% of the dye mixture of Example (1)

20% of sulfolane

0.01% of Mergal K9N

77.99% of water

using a drop-on-demand (bubble jet) ink jet print head. The print is fully dried. Fixation is effected by means of saturated steam at 102° C. for 8 minutes. The print is subsequently rinsed warm, subjected to a fastness wash with hot water at 95° C., rinsed warm and then dried to obtain a bluish red print having excellent service fastnesses.

1-10. (canceled)

11. A dye mixture comprising at least one dye of general formula (I) and at least one dye of general formula (II) 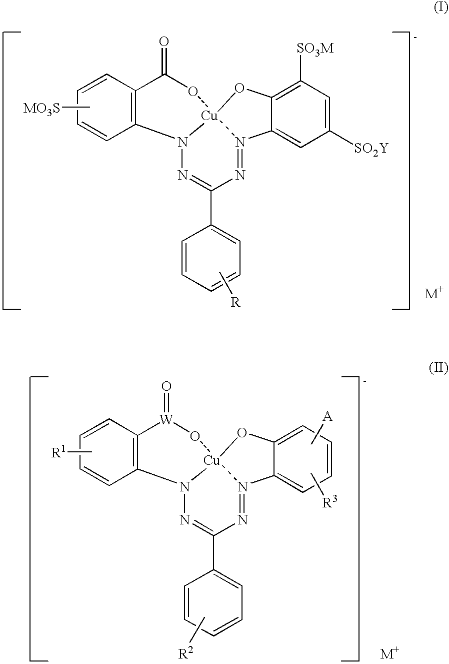
wherein
M is hydrogen, an alkali metal, an ammonium ion, or the equivalent of an alkaline earth metal ion;
Y is vinyl or CH₂CH₂Z, wherein Z is an alkali-eliminatable substituent;
R¹ is hydrogen or sulfo;
R² is hydrogen, sulfo, methyl, methoxy, carboxyl, or SO₂Y², wherein Y² is vinyl or CH₂CH₂Z, wherein Z is an alkali-eliminatable moiety;
R³ is hydrogen or sulfo;
R is hydrogen, sulfo, methyl, methoxy, carboxyl, or SO₂Y², wherein Y² is vinyl or CH₂CH₂Z, wherein Z is an alkali-eliminatable moiety;
W is C or —SO—;
A is a substituent having general formula (3) 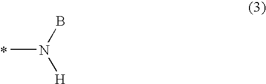
wherein
* is the bond to the formazan; and
B is a substituent having general formulae (4), (5), (6), or (7) 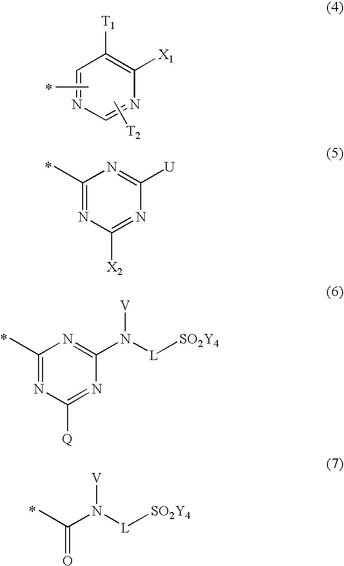
wherein
* is the bond to N of the substituent of formula (3);
U is a 5- or 6-membered N-attached heterocyclic ring optionally substituted with thio, oxo, or a substituent of general formula (8) 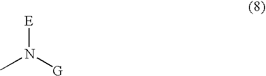
wherein
E is hydrogen; C₁-C₄-alkyl optionally substituted with methoxy, hydroxyl, sulfato, sulfo, or chloro; phenyl optionally substituted with 1 or 2 substituents selected from the group consisting of chloro, nitro, acetylamino, sulfo, hydroxyl, carboxyl, C₁-C₄-alkanoyl, C₁-C₄-alkoxy, and C₁-C₄-alkyl;
G is hydrogen; cyano; C₁-C₄-alkyl optionally substituted with methoxy, hydroxyl, sulfato, sulfo, or chloro; phenyl optionally substituted with 1 or 2 substituents selected from the group consisting of chloro, nitro, acetylamino, sulfo, hydroxyl, carboxyl, C₁-C₄-alkanoyl, C₁-C₄-alkoxy, and C₁-C₄-alkyl;
L is phenylene or naphthylene, wherein said phenylene and naphthylene are optionally substituted by up to two substituents selected from the group consisting of chloro, bromo, hydroxyl, C₁-C₄-alkoxy, C₁-C₄-alkyl, sulfo, cyano; or C₂-C₆-alkylene, wherein a methylene group of said C₂-C₆-alkylene is optionally replaced by 1 or 2 hetero groups;
Q is fluorine, chlorine, C₁-C₄ alkoxy, cyanamido, amino, C₁-C₄-alkylamino, dialkylamino, piperazine, morpholine, or a substituent having formula (9a) or (9b) 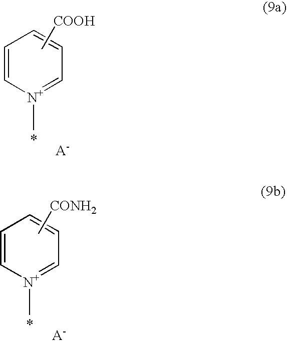
wherein
A⁻ is fluoride, chloride, or the equivalent of a sulfate ion;
V is hydrogen; C₁-C₄-alkyl optionally substituted with methoxy, hydroxyl, sulfato, sulfo, or chloro; phenyl optionally substituted with 1 or 2 substituents selected from the group consisting of chloro, nitro, acetylamino, sulfo, hydroxyl, carboxyl, C₁-C₄-alkanoyl, C₁-C₄-alkoxy, and C₁-C₄-alkyl;
T¹ is hydrogen, fluoro, or chloro;
T² is hydrogen, fluoro, or chloro, with the proviso that T¹ and T² are not simutaneously hydrogen;
X¹ is fluoro or chloro; and
X² is fluoro or chloro.

12. The dye mixture of claim 11, wherein
M is hydrogen or an alkali metal;
Y is vinyl or CH₂CH₂Z, wherein Z is sulfato, chloro, acetyl, phosphate, or thiosulfato;
R¹ is hydrogen or sulfo;
R² is SO₂Y₂, wherein Y² is CH₂CH₂Cl or vinyl;
R³ is hydrogen or sulfo;
R is SO₂Y², wherein Y² is CH₂CH₂Cl or vinyl;
W is C or —SO—;
A is a substituent having general formula (3) 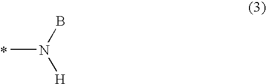
wherein
* is the bond to the formazan; and
B is a substituent having general formulae (4), (5), (6), or (7) 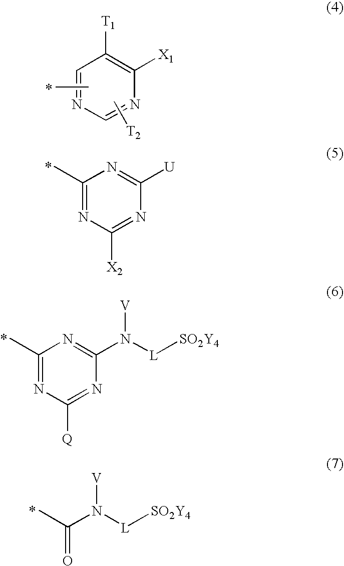
wherein
* is the bond to N of the substituent of formula (3);
U is morpholine, or a substituent having general formula (8) 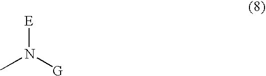
wherein
E is hydrogen, phenyl, 4-chlorophenyl, 3-sulfophenyl, methyl, 2-sulfoethyl, 2-hydroxyethyl, or 2-sulfatoethyl;
G is hydrogen;
L is phenylene or naphthylene, wherein said phenylene and naphthylene is optionally substituted with methoxy, methyl, ethyl, sulfo, cyano; or is C₂-C₆ alkylene, wherein a methylene group of said C₂-C₆-alkylene is optionally replaced by oxo, thio, amino, or C₁-C₄-alkylamino;
Q is fluoro, chloro, C₁-C₄ alkoxy, cyanamido, amino, C₁-C₄-alkylamino, dialkylamino, piperazine, morpholine, or a substituent having formula (9a) or (9b) 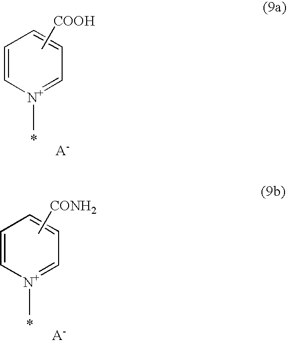
wherein
A⁻ is fluoride, chloride, or the equivalent of a sulfate ion;
V is hydrogen, methyl, phenyl, or sulfophenyl;
T¹ is hydrogen, fluoro, or chloro;
T² is hydrogen, fluoro, or chloro, with the proviso that T² and T¹ are not simultaneously hydrogen;
X¹ is fluoro or chloro; and
X² is fluoro or chloro.

13. The dye mixture of claim 11, wherein the at least one dye of general formula (I) and the at least one dye of general formula (II) comprise a mixture having a mixing ratio in the range of from 90:10% by weight to 10:90% by weight.

14. The dye mixture of claim 11, wherein the at least one dye of general formula (I) and the at least one dye of general formula (II) comprise a mixture having a mixing ratio in the range of from 70:30% by weight to 30:70% by weight.

15. A process for preparing the dye mixture of claim 11 comprising mechanically mixing the individual dyes having the formulae (I) and (II), wherein said dyes are present in solid or in liquid form, and in the requisite proportions.

16. A process for dyeing or printing hydroxyl- and/or carboxamido-containing material with the dye mixture of claim 11 comprising applying said dye mixture in dissolved form to the material and fixing said dye mixture on said material by means of heat, an alkaline agent, or a combination thereof.

17. The process of claim 16, wherein said hydroxyl- and/or carboxamido-containing material comprises fiber material.

18. A dye composition for dyeing and printing carboxamido-containing and/or hydroxyl-containing material comprising one or more reactive dyes of claim 11.

19. The dye composition of claim 8, wherein said carboxamido-containing and/or hydroxyl-containing material is fiber material.

20. An aqueous printing ink for textile printing by the ink jet process comprising one or more reactive dye mixtures of claim 11 in amounts of from 0.01% by weight to 40% by weight based on the total weight of the ink.
